(19) United States
(12) Patent Application Publication
(10) Pub. No.: US 2010/0025208 A1
(43) Pub. Date: Feb. 4, 2010

(54) Secure Enabling Switch

(75) Inventor: Joël Gauzin, Montpezat De Quercy (FR)

Correspondence Address: LERNER, DAVID, LITTENBERG,;KRUMHOLZ & MENTLIK, 600 SOUTH AVENUE WEST, WESTFIELD, NJ, 07090, US

(73) Assignee: APEM, Caussade (FR)

(21) Appl. No.: 12/460,743

(22) Filed: Jul. 23, 2009

(30) Foreign Application Priority Data
Jul. 23, 2008 (FR) 0855019

(51) Int. Cl. H01H 1/36; H01H 13/14

(52) U.S. Cl. 200/252; 200/341

(57) ABSTRACT

The present invention concerns a contact module able to set up electric contact between two fixed contacts (14) by means of a mobile contact (15) when pressure is applied to a transmission member in an actuation direction (X), comprising:
a body (7) carrying the two fixed contacts (14),
a transmission member (3, 5) carrying the mobile contact (15) and sliding within said body (7) in the actuation direction (X).

Said transmission member is formed of two parts (3, 5) and is able to contract in the actuation direction (X) when excessive pressure is applied to said member after electric contact has been made.

The mobile contact (15) is able to separate itself from at least one fixed contact (14) under the action of elastic means (12) when the transmission member (3, 5) is in its contracted state.

The invention also concerns an enabling switch incorporating said contact module.

### CROSS REFERENCE TO RELATED APPLICATION

This application claims the benefit of French Patent Application No. 0855019, filed on Jul. 23, 2008, in the French Patent Office the entire disclosure of which is incorporated herein by reference.

### BACKGROUND OF THE INVENTION

The present invention concerns a contact module and an enabling switch comprising said contact module.

When servicing a machine in fail-soft mode i.e. during a programming operation for example or during maintenance or testing, the operator uses a control switch whereby the machine only works if a pushbutton is held pressed down. Said device is said to have “enabling control”.

It may, for example, be integrated in a remote control that the operator holds during servicing.

Servicing may prove to be dangerous if the operator is in the vicinity of a moving machine when protection devices are neutralized.

To maintain operator safety in a panic situation in which the operator releases pressure on the pushbutton, the control switch must therefore enable the machine to be stopped.

Devices meeting this requirement have already proposed on the market.

These may assume two positions, namely an actuated position in which the contacts are closed when sufficient pressure is placed on the pushbutton, and a deactivated position in which the contacts are open when pressure on the pushbutton is released.

Yet, standard CEI 60947-5-8 has recently reinforced safety requirements.

This standard henceforth requires that enabling switches be designed so that in the event of excessive pressure being applied to the pushbutton—this case possibly corresponding to tense clenching by the user in a panic situation—the machine must also be stopped.

In other words, it is necessary to design a device in which both released pressure and excessive pressure lead to stoppage of the machine.

Documents EP 1 387 373 and EP 1 321 952 disclose such devices. The general principle of these devices is to provide a pushbutton consisting of two parts that are indexed one with respect to the other thanks to two sliders that are arranged so as to slide in a direction perpendicular to the actuating direction against the action of two springs.

Said sliders present a slope that cooperates with a corresponding slope of one of the parts of the pushbutton, so as to generate, when a pressure exceeding a predetermined pressure is applied to the pushbutton, a displacement of the sliders leading to the retraction of the pushbutton.

However, said sliders are usually made of a plastic material and, in particular if the slope is greater than 45°, they may brace themselves, which deteriorates the function of the device.

Besides, a violent pressure on the pushbutton can lead to shearing and breaking of the sliders, thereby not producing the expected security effect (i.e. cutting the circuit in the case of a strong pressure in a panic situation).

It is thus desirable to provide a device more robust and more liable than those of the prior art.

Additionally, it must optionally be possible to associate this device with supplementary safety devices in order to increase control safety.

### BRIEF DESCRIPTION OF THE INVENTION

According to the invention, a contact module is proposed capable of setting up electrical contact between two fixed contacts by means of a mobile contact when pressure is applied to a transmission member in an actuating direction, comprising:

a body carrying the two fixed contacts,

a transmission member carrying the mobile contact and sliding within said body in the actuating direction,

in which said transmission member is formed of two parts and is able to contract in the actuation direction when excessive pressure is applied to said member after electric contact has been set up, and in which the mobile contact is able to separate itself from at least one fixed contact under the action of elastic means when the transmission member is in its contracted state.

Said transmission member comprises:

an actuator element sliding in said body in the actuation direction against prompting by at least one elastic means,

a contact-holder carrying the mobile contact, slidingly mounted in said direction in a housing of the actuator element by means of an indexing system which retracts into said housing under the effect of excessive pressure applied to the actuator element when the contact-holder lies in abutment on the body,

and said mobile contact is able to slide in said direction on the contact-holder against the prompting of elastic means.

The indexing system of the contact-holder comprises two beads connected by elastic means substantially perpendicular to the actuation direction.

In particularly advantageous manner, the inner profile of the housing of the actuator element has a lower portion which widens in a bell shape from a narrower upper portion, said parts being joined by a shoulder, and so that, when at rest, the beads of the indexing system are housed in said shoulder and when excessive pressure is applied to the actuator element whilst the contact-holder is in abutment on the body, said elastic means contract thereby allowing the contact-holder to slide in the upper portion of said housing.

A further subject of the invention concerns an enabling switch comprising a casing and an actuator-button mobile in translation on the casing in said actuation direction, said switch comprising at least one contact module such as described above, arranged in the casing and cooperating with the actuator-button so that pressure on the actuator-button causes the transmission member to move in translation in its actuation direction.

The switch advantageously comprises a second contact module identical to the first and arranged in the casing adjacent thereto, which provides control safety

Further preferably, the switch also comprises an emergency stop module arranged in the casing adjacent said contact module(s), said emergency stop module comprising:

a body carrying at least two fixed contacts,

a pushbutton guide,

at least one pushbutton sliding in the guide in the actuation direction against at least one elastic means housed in the body, and carrying a mobile contact. At rest, the mobile contact is in contact with the fixed contacts, and there is clearance between the actuator-button and the pushbutton so that the application of moderate pressure on the actuator-button does not cause the pushbutton to move in translation.

A stabilizing bar is preferably arranged under the actuator-button so as to guarantee movement parallel to the direction of actuation.

### BRIEF DESCRIPTION OF THE DRAWINGS

Other characteristics and advantages of the invention will become apparent from the detailed description given below with reference to the appended drawings in which:

FIG. 1 is a diagram showing the functioning of the three-position contact module,

FIG. 2 shows cross-sectional views of one preferred embodiment of the invention, at rest (“position 1”),

FIG. 3 shows cross-sectional views of the same device under the effect of normal pressure on the pushbutton (“position 2”),

FIG. 4 shows cross-sectional views of the same device under the effect of greater pressure applied to the pushbutton,

FIG. 5 illustrates cross-sectional views of this same device when maximum pressure on the pushbutton is reached (“position 3”).

### DETAILED DESCRIPTION OF THE INVENTION

The secure enabling switch comprises a three-position contact module which allows the requirements of the standard to be met.

The three-position contact module will be described in more detail below. It chiefly comprises a body equipped with two fixed contacts connected to relays allowing the machine to be set in operation

Inside the body, a transmission member is arranged that is mobile in translation in the direction of actuation of the module, carrying a mobile contact.

The transmission member has the particular aspect of consisting of two parts whose connection mode is described in detail below, which makes it capable of contracting when excessive pressure is applied. Therefore the transmission member has a variable axial dimension (i.e. in the direction of actuation).

Also, the contact module comprises elastic means able to act on the mobile contact to separate the fixed contacts when the transmission member is in its contracted state.

The transmission member is actuated by means of a pushbutton, which allows electrical contact to be set up by bringing the mobile contact in contact with the two fixed contacts.

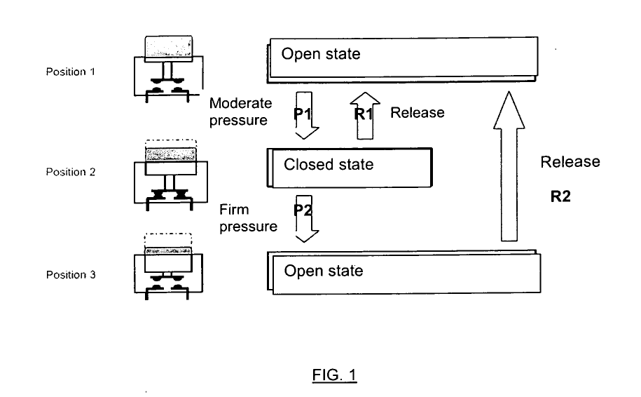

The operating principle of the contact module is explained below with reference to FIG. 1.

The contact module at rest (“position 1”) is in the open state. Since the contact is open, the machine is stopped. Also, the transmission member is in its free non-contracted state i.e. having its maximum axial dimension.

When moderate pressure is applied to the pushbutton (arrow P1), the module is in the closed state (“position 2”) for as long as this pressure is maintained. The contact being closed, the machine is in operation.

As soon as pressure on the pushbutton is released (arrow R1) the contact opens and the machine is stopped. This brings a return to position 1.

On the other hand, when the module is in the closed state (“position 2”), if the pressure on the pushbutton is increased to beyond a determined pressure (arrow P2), the transmission member then contracts and, under the action of the above-mentioned elastic means, the mobile contact separates itself from the fixed contacts breaking the electrical contact. The machine is stopped (“position 3”).

Finally if, from this latter position, the pushbutton is released (arrow R2), the module returns to rest position 1 whilst remaining in the open state. In other words, it returns to the rest position without passing through the closed state.

In particularly advantageous manner, the enabling switch comprises two identical three-position contact modules, placed side by side in a casing

This provides control redundancy and guarantees contact breakage even if the mechanism of one of the contact modules should fail for example.

According to a further preferred embodiment, an emergency stop module is incorporated in the switch just described.

It is this preferred embodiment of the invention, guaranteeing optimal safety by means of maximum redundancy, which will now be described in detail on the understanding that, as set forth above, a simplified device only comprising a single three-position contact module is also covered by the present invention.

As a variant, the enabling switch may comprise a single three-position contact module associated with an emergency stop module, without departing from the scope of the present invention.

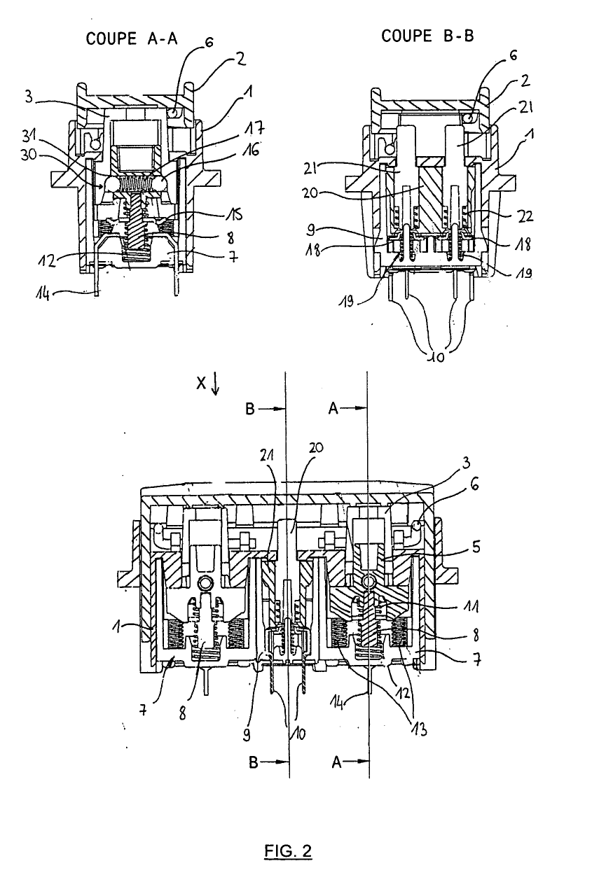

FIGS. 2 to 5 illustrate the different positions which may be assumed by the switch in relation to the pressure applied by the operator. The illustrated switch comprises two identical contact modules positioned either side of an emergency stop module.

In these figures, the direction of actuation X of the switch is shown. In the remainder hereof when mention is made of a translation movement, it relates to translation parallel to direction X unless specified to the contrary.

Rest Position (“Position 1”)

With reference to FIG. 2, the three-position contact module comprises a body 7, equipped with two electric contacts e.g. terminal lugs 14.

The body 7 is housed in the casing 1 of a switch, intended to be mounted on the remote control of a machine for example.

The terminal lugs 14 are connected to relays for example (not shown) which, when electric contact is set up between the terminal lugs, allow the machine to be started up.

An actuator-button 2 mobile in translation in the casing 1 allows the device to be actuated.

Inside the body 7, a retractable transmission member comprising an actuator element 3 and a contact-holder 5 equipped with a mobile contact 15, an end-piece 8 and a spring 11 is mobile in translation in actuation direction X.

The actuator element 3 is mobile in translation inside the body 7 against two lateral elastic means such as springs 13 housed in the body 7.

In rest position, the actuator element 3 is held in abutment on the actuator-button 2 by the two springs 13.

Along cross-section A-A, the actuator element 3 is substantially in the shape of a bell and defines an inner housing 30 whose profile has a substantially parallelepiped upper portion and a lower portion which flares downwardly.

At the junction between the two parts of the housing 30, a rounded shoulder 31 can be seen.

This profile imparts a cam function to the inside of the housing 30, along which two beads 16 can move, elastic means such as a spring 17 being inserted between the beads.

When at rest, the spring 17 holds the beads 16 in abutment against the rounded shoulder 31.

The assembly consisting of the beads 16 and spring 17 forms an indexing system for the contact-holder 5 relative to the actuator element 3, which allows the transmission member to contract.

As will be seen below, an upward pressure exerted on the beads tends to compress the spring 17 and cause the beads to slide into the narrower upper portion of the housing 30. This indexing system can therefore retract into the housing 30.

The contact-holder 5 is pierced with a bore perpendicular to the direction of actuation, in which the two beads 16 and the spring 17 are arranged.

The assembly consisting of the contact-holder 5, the end-piece 8, the mobile contact 15 and the spring 11 is therefore housed inside the actuator element 3 and held therein by means of the indexing system 16, 17 which, at rest and for as long as the pressure applied to the actuator element 3 is lower than a determined pressure, lies in abutment in the shoulder 31.

The end-piece 8, of substantially cylindrical shape, is rigidly joined in its upper part to the contact-holder 5.

The mobile contact 15 is mobile in translation along the upper part of the end-piece 8, against an elastic means such as a so-called “overtravel” spring 11.

The spring 11 is mounted in a housing of the contact-holder 5.

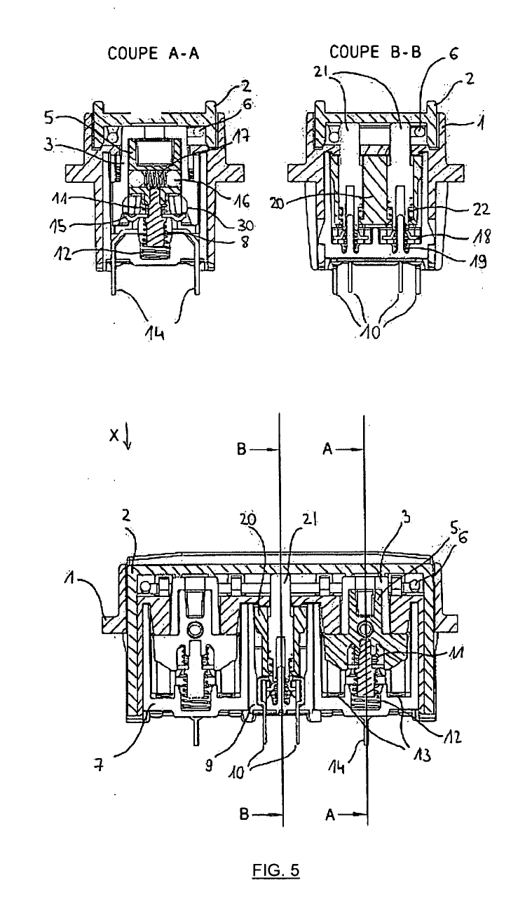

When at rest, the spring 11 maintains the bearing of the mobile contact 15 against an abutment 80 located substantially in the centre of the end-piece 8 (better visible FIG. 5).

Also, when at rest, the central spring 12 holds the contact-holder 5 in abutment against the casing 1.

Application of Moderate Pressure to the Actuator Member

When pressure is applied to the actuator-button 2 this drives the actuator element 3 and, by means of the indexing system 16, 17, the contact-holder 5.

The transmission member then acts as a rigid assembly.

After movement corresponding to pre-travel (partial compression) of the central spring 12, the contact 15 comes to touch the two terminal lugs 14 to ensure electric connection between these two terminal lugs.

The actuator-button 2 continues to move and the overtravel spring 11 is compressed until the end-piece 8 abuts against the body 7 at the bottom of the housing of the central spring 12.

The electric connection between the terminal lugs 14 remains ensured.

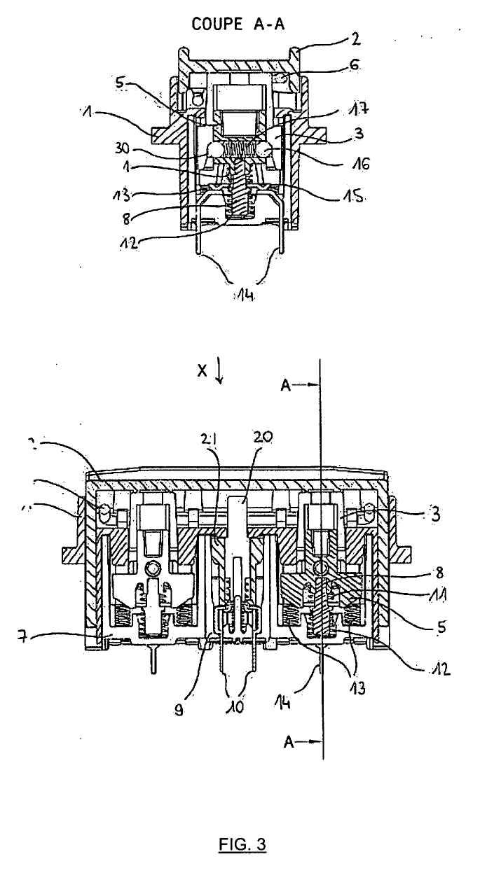

This situation (“position 2”) is illustrated FIG. 3.

If the operator releases pressure on the actuator-button 2, the actuator element 3 and the contact-holder 5 return to their rest position (“position 1”) under the effect of springs 12 and 13.

The electric connection between the terminal lugs 14 is then broken, which causes stoppage of the machine.

Application of Strong Pressure to the Actuator Member (Tense Clenching)

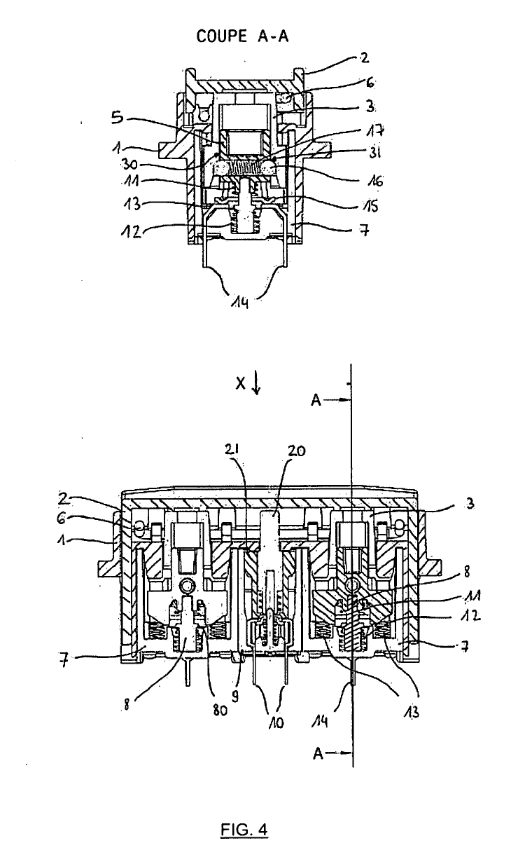

FIG. 4 illustrates the situation in which the operator exerts stronger pressure than intended normal pressure. This corresponds for example to the case in which, in a danger situation, the operator squeezes the pushbutton.

The actuator-button 2 exerts pressure on the actuator element 3.

However, the end-piece 8 of the contact-holder 5 being in abutment against the body 7, the contact-holder cannot move further in translation.

Force is then exerted on the two indexing beads 16 which lie in abutment in the shoulder 31 of the housing 30 of the actuator element 3.

Under this force, the beads 16 compress the spring 17 and withdraw into the narrowest part of the housing 30.

It will be noted that, due to their spherical shape, the beads 16 are not subject to bracing or shearing that occur in the prior art.

Furthermore, they are preferably made of stainless steel, which makes them very robust.

The transmission member is then in its contracted state.

Once the beads 16 are in the upper portion of the housing 30, the force of the actuator element 3 exerted on the contact-holder 5 via these beads no longer has any vertical component.

The connection between the actuator element 3 and the contact-holder 5 then becomes a sliding connection.

Under the effect of the central spring 12, the contact-holder 5 is brought back into rest abutment on the casing 1.

The electric connection between the terminal lugs 14 is then interrupted, which leads to stoppage of the machine.

The actuator-button 2 can continue its stroke until it comes to abut against the casing 1, without causing the contact-holder 5 to move.

The situation then becomes “position 3” as illustrated FIG. 5.

When the actuator-button 2 is released by the operator, the springs 13 cause the actuator element 3 to rise back thereby driving the actuator-button 2 towards its rest position (“position 1”).

During this phase, since the contact-holder 5 is already in abutment in its rest position, it remains immobile.

The contact between the terminal lugs 14 therefore remains open without passing through a closed state.

The actuator element 3, when sliding relative to the contact-holder, allows the beads 16 to resume their initial position moving down along the housing 30 as far as the rounded shoulder 31 and thereby to “reset” the indexing system of the contact-holder 5.

The transmission member then resumes its initial, non-contracted, position. The switch has then returned to position 1.

Emergency Stop Module

As set forth above, it is of particular advantage to further secure the device by means of a module of “emergency stop” type which will now be described with reference to FIGS. 2, 4 and 5.

The emergency stop module comprises a body 9 housed in the casing 1.

The module here is a dual-contact module whose redundancy is provided to secure the functioning thereof, but it is to be appreciated that a single-contact module operating along the same principle could be used.

The body 9 is equipped with four fixed contacts, such as terminal lugs 10 connected to relays which, when electric contact is ensured between the terminal lugs, allows the machine to be set in operation.

In this emergency stop module, the contacts are said to be “normally closed”.

In the rest position illustrated FIG. 2, two mobile contacts 18 are therefore held in contact against the terminal lugs 10.

Also, a pushbutton guide 20 is joined to the body 9 and allows the guiding in translation of two pushbuttons 21 each of the pushbuttons being equipped with a mobile contact 18.

Each pushbutton 21 is held in abutment against the casing 1 by means of a pushbutton spring 22.

Two contact springs 19 are housed in the lower part of the body 9 so that each thereof exerts a force on the corresponding mobile contact 18 and holds it in abutment against two terminal lugs 10, thereby ensuring electric connection between these two terminal lugs.

It will be noted that there is clearance between the top part of the pushbuttons 21 and the actuator-button 2, so that pressure can be applied to actuator-button 2 without causing action on the pushbuttons 21.

This clearance is determined so that, when the operator applies normal pressure to set the machine in operation, the operator does not exert any action on the emergency stop module and the electric contacts between the terminal lugs 10 remain ensured.

This is why this situation is not shown in cross-section B-B in FIGS. 3 and 4, since the state of the emergency stop module remains unchanged compared with FIG. 2.

When the operator applies greater pressure to the actuator-button, for example if it is tightly clenched by the operator, the actuator-button 2 comes to touch the top part of the pushbuttons 21 and drives these pushbuttons in translation, compressing the springs 22.

When the springs 22 are compressed, it is the mobile contacts 18 which are driven downward in translation, thereby breaking the electric contact between the terminal lugs 10.

This leads to position 3, as illustrated FIG. 5.

The emergency stop module therefore ensures the secured breaking of electric contact when the actuator-button is clenched in a tense situation.

When the operator releases pressure on actuator-button 2, the springs 19 and 22 are relaxed and allow the contacts to close and the pushbuttons 21 to return to abutment on the casing 1.

The switch has then returned to the rest position (“position 1”) shown FIG. 2.

In particularly advantageous manner, the actuator-button 2 is guided in its movement by the casing 1 and is held parallel by means of a stabilizing bar 6, which ensures simultaneous opening and closing of the contacts through movement parallel to the direction of actuation.

The forces and compression travel lengths of the elastic means used in the emergency stop module are sized by persons skilled in the art so as to obtain the desired switch characteristics (normal actuating pressure, normal actuator travel length, pressure considered to be excessive . . . ).

Evidently the examples just given are only particular illustrations and are in no way limiting regarding the areas of application of the invention.

For example, the illustrated elastic means in the figures are springs, but it is to be appreciated that they can be replaced by any other means fulfilling the same function.

The enabling switch can be used in the area of cranes, forklift trucks and other handling systems, for the driving of vehicles such as tractors, trains or trams, snow-ploughs, jet-skis, cableways, hazardous tooling (mowing machines, reaping machines) but also for robotic programming of machine tools or automated equipment.

The switch can advantageously be incorporated in a remote control, a joystick handle or a pedal.

Finally, even if actuation of the three-position contact module, and optionally of the emergency stop module, is achieved by means of an actuator-button translating in the casing, this actuator-button can itself be actuated by any type of actuator such as a button, a lever, a toggle, a trigger, a pedal . . . . The invention can therefore be applied to any type of switch.

1. Contact module able to set up electric contact between two fixed contacts (14) by means of a mobile contact (15) when pressure is applied to a transmission member in an actuation direction (X), comprising:
a body (7) carrying the two fixed contacts (14),
a transmission member (3,5) carrying the mobile contact (15) and sliding within said body (7) in the actuation direction (X), wherein:
said transmission member is formed of two parts (3,5) and is able to contract in the actuation direction (X) when excessive pressure is applied to said member after electric contact has been set up,
the mobile contact (15) is able to separate itself from at least one fixed contact (14) under the action of elastic means (12) when the transmission member (3, 5) is in its contracted state,
said transmission member comprises:
an actuator element (3) sliding within said body (7) in the actuation direction (X) against prompting by at least one elastic means (13),
a contact-holder (5) carrying the mobile contact (15), slidingly mounted in said direction (X) in a housing (30) of the actuator element (3) by means of an indexing system (16, 17) which can retract into said housing (30) under the effect of excessive pressure applied to the actuator element (3) when the contact-holder (5) lies in abutment on the body (7),
said mobile contact (15) being able to slide in said direction (X) on the contact-holder (5) against prompting action by elastic means (11), wherein the indexing system of the contact-holder (5) comprises two beads (16) connected by elastic means (17) substantially perpendicular to the actuation direction (X).

2. Module according to claim 1, characterized in that the inner profile of the housing (30) of the actuator element (3) has a lower portion widening into a bell shape from a narrower upper portion, said parts being joined by a shoulder (31), so that when at rest the beads (16) of the indexing system are housed in said shoulder (31) and when excessive pressure is applied to the actuator element (3) whilst the contact-holder (5) lies in abutment on the body (7), the elastic means (17) contract enabling the contact-holder (5) to slide in the upper portion of the housing (30).

3. Enabling switch comprising a casing (1) and an actuator-button (2) mobile in translation on the casing in said actuation direction (X), characterized in that it comprises at least one contact module according to any of claims 1 or 2 arranged in the casing (1) and cooperating with the actuator-button (2) so that pressure on the actuator-button (2) drives the transmission member (3, 5) in translation in its actuation direction (X).

4. Switch according to claim 3, characterized in that it comprises a second contact module identical to the first and arranged in the casing (1) adjacent thereto.

5. Switch according claim 3, characterized in that it further comprises an emergency stop module arranged in the casing (1) adjacent said contact module(s), said emergency stop module comprising:
a body (9) carrying at least two fixed contacts (10),
a pushbutton guide (20),
at least one pushbutton (21) sliding in the guide (20) in actuation direction (X) against at least one elastic means (19) housed in the body (9), and carrying a mobile contact (18),
and in that, at rest, the mobile contact (18) is in contact with the fixed contacts (10) and there is clearance between the actuatior-button (2) and the pushbutton (21), so that application of moderate pressure to the actuator-button (2) does not drive the pushbutton (21) in translation.

6. Switch according to claim 3, characterized in that a stabilizing bar (6) is arranged underneath the actuator-button (2) so as to guarantee movement parallel to the actuation direction (X).
